(19) United States
(12) Patent Application Publication
(10) Pub. No.: US 2025/0253765 A1
(43) Pub. Date: Aug. 7, 2025

(54) EMI FILTERING CIRCUIT FOR EV/HEV BATTERY CHARGERS

(71) Applicant: META SYSTEM S.P.A., REGGIO EMILIA (RE) (IT)

(72) Inventor: Cesare LASAGNI, REGGIO EMILIA (RE) (IT)

(21) Appl. No.: 18/856,600

(22) PCT Filed: Apr. 13, 2023
(86) PCT No.: PCT/IB2023/053791

§ 371 Date: Oct. 11, 2024

(30) Foreign Application Priority Data
Apr. 14, 2022 (IT) 102022000007538

(51) Int. Cl. H02M 1/44; B60L 53/22; H01F 27/30; H01F 37/00; H02J 7/02; H02M 7/00

(52) U.S. Cl. CPC H02M 1/44; B60L 53/22; H01F 27/306; H01F 37/00; H02J 7/02; H02M 7/003; H02J 2310/48

(57) ABSTRACT

A filtering circuit (1) for battery chargers of electric or hybrid vehicles. which comprises at least one electromagnetic interference filter (2, 8) provided with at least one coil (2) comprising: one ferromagnetic core (3): four windings (4a, 4b) each of which is wound around a respective winding portion (5a, 5b) of the ferromagnetic core (3) and is provided with one input end (6) and with one output end (7): at least one line capacitor (8): wherein each of the windings (4a, 4b) comprises: a first plurality of turns (4a) provided with the input end (6) and wound around a respective first winding portion (5a) of the ferromagnetic core (3): and a second plurality of turns (4b) provided with the output end (7) and wound around a respective second winding portion (5b) of the ferromagnetic core (3) opposite the first winding portion (5a).

### TECHNICAL FIELD

The present invention relates to a filtering circuit for battery chargers of electric or hybrid vehicles.

### BACKGROUND ART

As is well known, electric vehicles use for propulsion the conversion of part of the chemical energy stored in one or more batteries into electrical energy and the subsequent transfer of the latter to the motorized unit.

For the purpose of enabling periodic charging of batteries, electric and hybrid vehicles are provided with special battery chargers (so-called “on-board chargers”, OBCs), which can be connected at input to an AC power supply line and at output to the vehicle battery, which chargers are adapted to convert the AC current at input into a corresponding, predefined DC current to be sent at outlet to the battery for storage.

In this regard, it should be mentioned that the above conversions are carried out, in the battery charger, by a power unit operating at high voltages and because of this fact, they may generate electromagnetic disturbances that are likely to be propagated to the power supply line.

In order to overcome this problem, battery chargers are provided with filtering circuits intended to filter such electromagnetic disturbances coming from downstream.

An example of known filtering circuits is provided in FIGS. 1 through 3.

Specifically, as visible in FIG. 1, the known filtering circuits C comprise one or more filters F for electromagnetic disturbances (e.g., of the EMI filter type) comprising a coil B and a plurality of line capacitors CND.

Specifically, the coil B comprises a ferromagnetic core N and four windings V each wound around a respective winding portion P of the ferromagnetic core N. The coil B may have various and different conformations; it can, e.g., be toroidal (as shown in FIGS. 1 and 2), or it can be substantially oval-shaped (as shown in FIG. 3), that is, composed of two straight stretches, parallel to each other, and two curvilinear connecting stretches located between the two straight stretches.

As for the windings V, each of them comprises an input end IN and an output end OUT opposite each other with respect to the winding portion P, where the input ends IN are connectable to the three phases and to the neutral of a three-phase AC power supply line and the output ends OUT are connectable to the power unit.

Specifically, in the event of the filtering circuit being provided with a single filter F, then it is possible to directly connect its four input ends IN and its four output ends OUT to the power supply line and to the power unit, respectively.

In this way, it is possible to define four input connections between the single filter F and the power supply line and four output connections between the single filter F and the power components.

The filtering circuit may alternatively comprise a plurality of filters F.

Specifically, if the filtering circuit comprises two filters F (as shown in FIG. 2 by way of example), then it is possible to connect the input ends IN of one of the two filters F to the power supply line, the output ends OUT of the other of the two filters F to the power unit and to connect the two filters F to each other via the remaining input ends IN and output ends OUT to define, between them, four intermediate connections.

Thus, in this case, one of the two filters F is directly connected at input to the power supply line and is provided with the input connections, while the other of the two filters F is directly connected at output to the power unit and is provided with the output connections.

In all cases, the known filtering circuits suffer from an important issue that makes them amenable to improvement.

It must, in fact, be specified that the connections defined by the input ends IN and by the output ends OUT are made by means of tracks made of conductive material, e.g., copper, side by side, or located in intermediate layers, on a suitable insulating printed circuit board S.

This geometric characteristic causes capacitive coupling being created between the input connections and the output connections and, therefore, some of the electromagnetic disturbances coming from downstream, by coupling to the input connections and to the output connections in a capacitive manner, is carried towards the power supply line.

It is easy to appreciate, then, that such issues end up greatly reducing the effectiveness of known filtering circuits against electromagnetic disturbances generated by high-voltage conversions.

### DESCRIPTION OF THE INVENTION

The main aim of the present invention is to devise a filtering circuit for battery chargers of electric or hybrid vehicles which allows filtering the electromagnetic disturbances coming from downstream in a more effective manner than the prior art mentioned above.

Another object of the present invention is to devise a filtering circuit for battery chargers of electric or hybrid vehicles which allows the aforementioned drawbacks of the prior art to be overcome within the framework of a simple, rational, easy and effective to use as well as cost-effective solution.

The aforementioned objects are achieved by this filtering circuit for battery chargers of electric or hybrid vehicles having the characteristics of claim 1.

### BRIEF DESCRIPTION OF THE DRAWINGS

Other characteristics and advantages of the present invention will become more apparent from the description of a preferred, but not exclusive, embodiment of a filtering circuit for battery chargers of electric or hybrid vehicles, illustrated by way of an indicative, yet non-limiting example, in the accompanying tables of drawings in which:

FIG. 1 is an axonometric, overall view of a filtering circuit of known type;

FIG. 2 is a schematic view of a detail of the known filtering circuit;

FIG. 3 is a schematic view of a detail of the known filtering circuit according to a different embodiment;

FIG. 4 is a schematic view of the filtering circuit according to the invention;

FIG. 5 is an axonometric, detailed view of a detail from FIG. 4;

FIG. 6 shows a section, carried out along the sectional plane VI-VI, from FIG. 5.

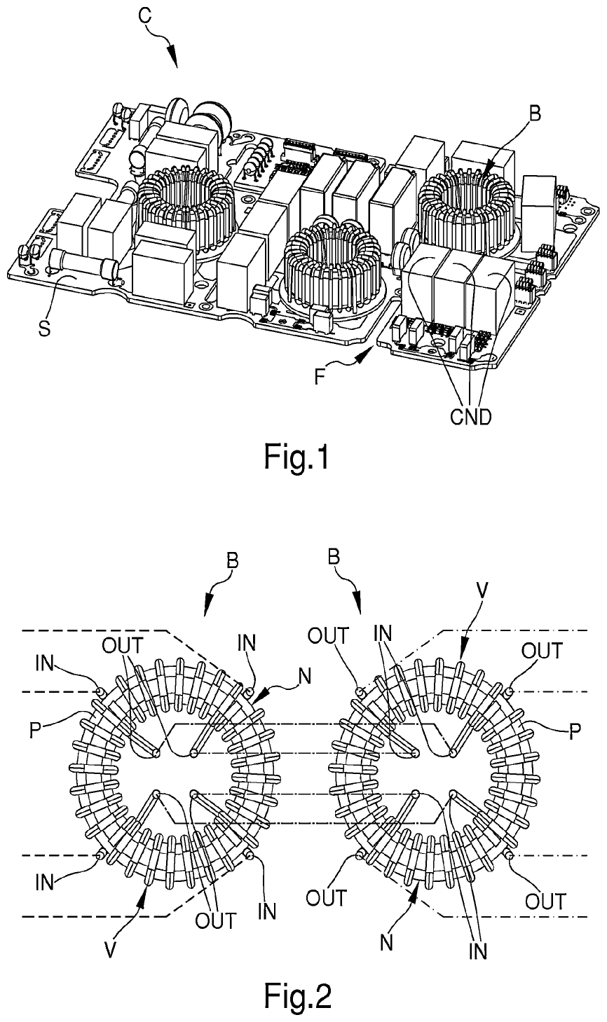

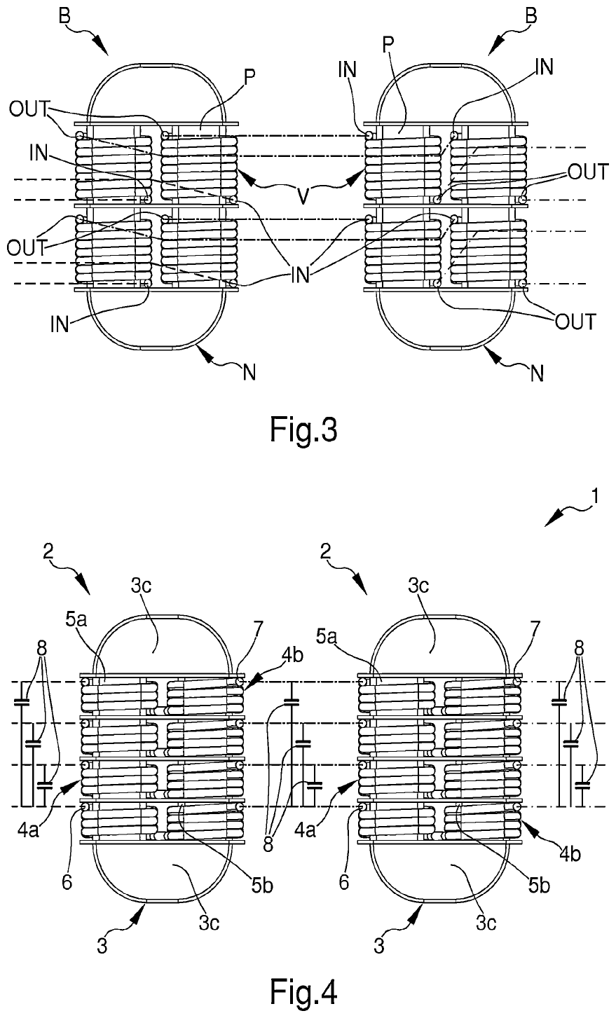

### EMBODIMENTS OF THE INVENTION

With particular reference to FIGS. 4 through 6, reference numeral 1 globally indicates a filtering circuit for battery chargers of electric or hybrid vehicles.

The filtering circuit 1 for battery chargers of electric or hybrid vehicles can be installed in at least one battery charger of electric or hybrid vehicles which is provided with at least one power unit for converting alternating current to a predefined direct current.

In this case, the circuit 1 comprises at least one printed circuit board and at least one filter 2, 8 from electromagnetic disturbances associated with the printed circuit board.

In the present case, the filter 2, 8 has at least one coil 2 comprising:
at least one ferromagnetic core 3;
at least four windings 4a, 4b, each of which is wound around a respective winding portion 5a, 5b of the ferromagnetic core 3 and is provided with at least one input end 6 connectable to one of the three phases or to the neutral of at least one alternating current power supply line, and with at least one output end 7 connectable to the power unit.

In actual facts, referring to a configuration of use of the circuit 1 wherein it is installed on a battery charger and is connected to the power supply line and to the power unit, each three of the four input ends 6 are connected to one of the three phases, while the fourth input end 6 is connected to the neutral.

By explaining the ferromagnetic core 3 in detail, it should first be said that it is preferably made of a ferromagnetic metal (e.g., iron) or ferromagnetic compounds marked by low coercivity and low hysteresis.

In particular, the ferromagnetic core 3 is made of at least one amorphous or nanocrystalline alloy.

Such alloys do, in fact, offer excellent performance (e.g., saturation induction greater than 0.9 T, high relative magnetic permeability and excellent stability under varying temperature) for working frequencies on the order of a few tens of kHz and for applications under critical environmental conditions.

Specifically, the choice of an amorphous ferromagnetic core 3 is particularly suitable in the case of manufacturing a filter 2, 8 of extremely compact size and traversed by high direct currents with small high-frequency components.

In fact, in this case, the saturation induction level of the ferromagnetic core 3 enables the same to control high currents effectively, limiting the losses thereof in the face of their low ripple.

What's more, a ferromagnetic core 3 made of nanocrystalline alloy features decidedly low losses not only for limited current ripples but also for considerable variations in the magnetic field, making it suitable for the construction of switching transformers.

Ultimately, making the ferromagnetic core 3 from amorphous or nanocrystalline alloy allows, for the same size and number of turns, much higher inductances to be achieved than using materials such as ferrite, thus enabling the filter 2, 8 to perform its function in a particularly efficient manner.

In terms of conformation, as clearly visible in FIG. 6, the ferromagnetic core 3 in accordance with the preferred embodiment comprises:
at least a first stretch 3a, substantially rectilinear in shape;
at least a second stretch 3b, substantially rectilinear in shape and arranged substantially parallel side by side to the first stretch 3a;
at least two connecting stretches 3c, substantially curvilinear in shape and positioned between the first stretch 3a and the second stretch 3b to connect the latter to each other so as to make a closed ferromagnetic core 3.

Specifically, the first stretch 3a and the second stretch 3b have substantially coincident lengths.

Again, the connecting stretches 3c are substantially shaped as a D.

In actual facts, the ferromagnetic core 3 is substantially oval-shaped.

However, different conformations of the ferromagnetic core 3, e.g. substantially toroidal, cannot be ruled out.

In this case, the winding portions 5a, 5b have a substantially curved conformation and the windings 4a, 4b are wound on the winding portions themselves in a curvilinear manner.

Again, the ferromagnetic core 3 is made in a single body piece.

In other words, the first stretch 3a, the second stretch 3b and the connecting stretches 3c are connected to each other continuously and without the interposition of any welding joints.

It should, in this regard, be borne in mind that it is precisely the special oval shape of the ferromagnetic core 3 that allows the latter to be made as a single body piece and, therefore, to disregard the use of welding joints to connect the aforementioned stretches 3a, 3b, 3c.

This fact makes it possible to dramatically increase the magnetic properties (e.g., inductance) of the ferromagnetic core 3, consequently leading to even more effective control of the currents.

In addition, the filter 2, 8 comprises at least one line capacitor 8 connected to at least one of either the input ends 6 or the output ends 7.

Specifically, the filter 2, 8 comprises a plurality of line capacitors 8.

Specifically, some of the line capacitors 8 are connected to the input ends 6 and the others are connected to the output ends 7.

As visible in FIG. 4, the line capacitors 8 are arranged between each phase and the neutral or between two phases.

The filter 2, 8 is substantially of the type of an EMI filter.

According to the invention, each of the windings 4a, 4b comprises a first plurality of turns 4a provided with the input ends 6 and wound around a respective first winding portion 5a of the ferromagnetic core 3.

Specifically, the turns belonging to the first plurality of turns 4a are all side by side to each other and are aligned with each other along at least a first axis of winding A1.

Similarly, the windings 4a, 4b also comprise a second plurality of turns 4b, connected to the first plurality of turns 4a, which is provided with the output end 7 and is wound around a respective second winding portion 5b of the ferromagnetic core 3 substantially opposite the first winding portion 5a.

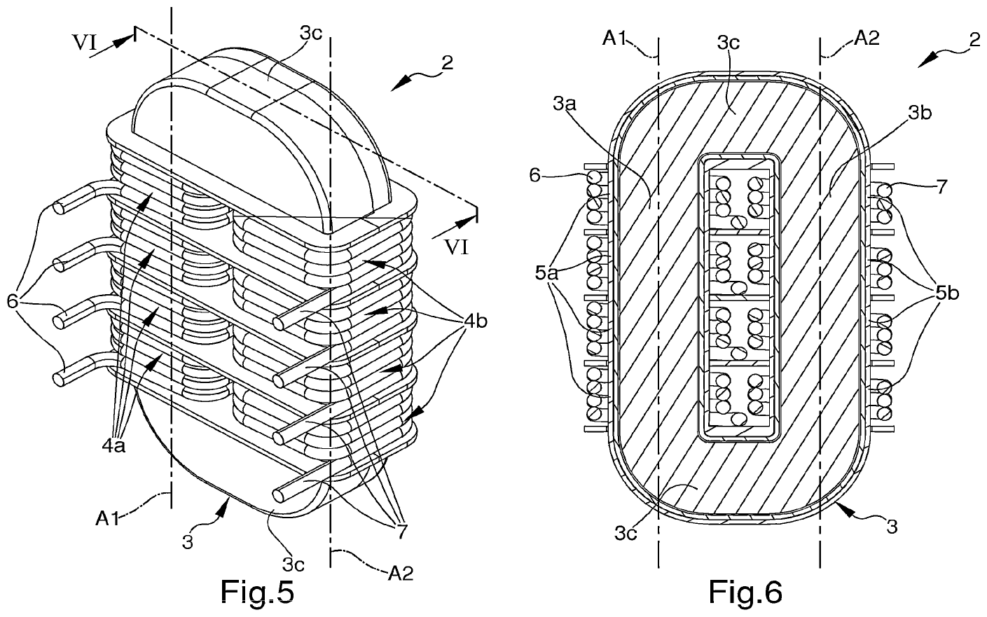

In particular, the turns belonging to the second plurality of turns 4b are all side by side to each other and are aligned with each other along at least a second axis of winding A2 parallel to and separate from the first axis of winding A1 (see FIG. 5 and FIG. 6 in this regard).

It is emphasized, at this point, that providing a first plurality of turns 4a provided with the input end 6 and a second plurality of turns 4b provided with the output end 7 allows the input ends 6 to be connected to the power supply line and the output ends 7 to the power unit while keeping the connections thus defined spaced apart from each other.

This fact averts the risk that capacitive coupling may be created between the input connections and the output connections; thus, electromagnetic disturbances generated by high-voltage conversions are effectively filtered by the circuit 1, which prevents them from entering the network.

Specifically, the first pluralities of turns 4a of the windings 4a, 4b are wound on the first stretch 3a and the second pluralities of turns 4b of the windings 4a, 4b are wound on the second stretch 3b.

In this regard, referring to the preferred embodiment, to state that the first winding portions 5a and the second winding portions 5b are opposite each other is to mean that they are arranged on two straight, separate and mutually parallel stretches of the ferromagnetic core 3.

In other words, to state this is to say that the first axis of winding Al and the second axis of winding A2 lie on the first stretch 3a and on the second stretch 3b respectively, and are parallel to the latter.

Conveniently, the first pluralities of turns 4a are wound around the first winding portions 5a with at least a first direction of winding and the second pluralities of turns 4b are wound around the second winding portions 5b with at least a second direction of winding opposite the first winding direction.

As is clearly visible in FIGS. 4 to 6, the first direction of winding is clockwise and the second direction of winding is counterclockwise.

The opposite case cannot however be ruled out wherein the first direction of winding is counterclockwise and the second direction of winding is clockwise.

In this regard, it should be pointed out that the direction of winding of the turns causes the orientation of the electric current flowing through them and, consequently, the direction of the magnetic field generated by it.

With this in mind, it is, therefore, easy to appreciate that the special expedient of winding the first plurality of turns 4a and the second plurality of turns 4b with opposite directions of winding makes it possible to generate magnetic fields having equal directions to each other and, therefore, to sum their respective inductances, thus increasing the filtering effectiveness of the circuit 1.

Conveniently, the input end 6 and the output end 7 of each of the windings 4a, 4b are substantially aligned with each other on the first stretch 3a and on the second stretch 3b, respectively.

This fact operates in conjunction in further increasing the filtering effectiveness of the filtering circuit 1 over what has already been described, since it allows the connections to be aligned with each other and, therefore, prevents these from being side by side at certain stretches.

According to a first embodiment, the circuit 1 comprises a single filter 2, 8 and, consequently, a single coil 2.

In this case, the input ends 6 of the single coil 2 are directly connectable to the power supply line, and similarly, the output ends 7 of the single coil 2 are directly connectable to the power unit.

It is specified, in this regard, that by using the term “directly” with reference to the connection between the input ends 6 and the power supply line, it is meant that no additional electrical component (such as, e.g., an additional coil 2) is located between these two.

Similar considerations may apply when employing the aforementioned term in reference to the connection between the output ends 7 and the power unit. Alternatively, in accordance with a second embodiment, the circuit 1 comprises a plurality of filters 2, 8 connected in series to each other and, consequently, a plurality of coils 2.

In this case, the input ends 6 of the first coil 2 and the output ends 7 of the last coil 2 are directly connectable to the power supply line and to the power components, respectively.

In addition, the output ends 7 of each coil 2, except for the last one, are directly connected to the input ends 6 of each next coil 2 to define, between two next filters 2, 8, four intermediate connections which are parallel to each other.

Keeping in mind the arrangement of the input ends 6 and of the output ends 7 previously described, it is easy to appreciate how, in this second embodiment, all connections (i.e., input connections, output connections and intermediate connections) are aligned along four lines parallel to each other (see FIG. 4 in this regard).

Preferably, the circuit 1 comprises three filters 2, 8 connected in series.

In this case, the circuit 1 is thus provided with four input connections with the power supply line, four output connections with the power unit and eight intermediate connections between the various filters 2, 8 in series (i.e., four between the first and the second filter 2, 8 and another four between the second and the third filter 2, 8).

It cannot, however, be ruled out that the circuit 1 may have a different number of filters 2, 8, e.g., two filters 2, 8 connected in series or a different and, for example, larger number of filters 2, 8.

It has in practice been ascertained that the described invention achieves the intended objects.

In particular, the fact is emphasized that providing a first plurality of turns provided with the input end and a second plurality of turns provided with the output end allows the latter to be connected to the power supply line and to the power unit while keeping the connections thus defined spaced apart from each other.

This fact averts the risk that capacitive coupling may be created between the input connections and the output connections; in this way, electromagnetic disturbances generated by high-voltage conversions are effectively filtered by the filtering circuit, which prevents these from entering the network.

1) Filtering circuit (1) for battery chargers of electric or hybrid vehicles, which can be installed in at least one battery charger of electric or hybrid vehicles which is provided with at least one power unit for converting alternating current into predefined direct current, comprising at least one electromagnetic interference filter (2, 8) provided with:
at least one coil (2) comprising:
at least one ferromagnetic core (3);
at least four windings (4a, 4b) each of which is wound around a respective winding portion (5a, 5b) of said ferromagnetic core (3) and is provided with at least one input end (6) connectable to one of the three phases or to the neutral of at least one alternating current power line, and with at least one output end (7) connectable to said power unit;
at least one line capacitor (8) connected to at least one of either said input ends (6) or said output ends (7);
characterized by the fact that each of said windings (4a, 4b) comprises a first plurality of turns (4a) provided with said input end (6) and wound around a respective first winding portion (5a) of said ferromagnetic core (3), and a second plurality of turns (4b) connected to said first plurality of turns (4a), provided with said output end (7) and wound around a respective second winding portion (5b) of said ferromagnetic core (3) opposite said first winding portion (5a).

2) Circuit (1) according to claim 1, characterized by the fact that said ferromagnetic core (3) comprises:
at least a first stretch (3a), substantially rectilinear in shape, on which are wound said first plurality of turns (4a) of said windings (4a, 4b);
at least a second stretch (3b), substantially rectilinear in shape and arranged side by side substantially parallel to said first stretch (3a), on which are wound said second plurality of turns (4b) of said windings (4a, 4b);
at least two connecting stretches (3c), substantially curvilinear in shape and positioned between said first stretch (3a) and said second stretch (3b) to connect the latter to each other.

3) Circuit (1) according to claim 2, characterized by the fact that said input end (6) and said output end (7) of each of said windings (4a, 4b) are substantially aligned with each other on said first stretch (3a) and on said second stretch (3b), respectively.

4) Circuit (1) according to claim 1, characterized by the fact that said first plurality of turns (4a) are wound around said first winding portions (5a) with at least a first winding direction, and that said second plurality of turns (4b) are wound around said second winding portions (5b) with at least a second winding direction opposite said first winding direction.

5) Circuit (1) according to claim 1, characterized by the fact that it comprises a single said filter (2, 8), said input ends (6) of said single coil (2) being directly connectable to said power line and said output ends (7) of said single coil (2) being directly connectable to said power unit.

6) Circuit (1) according to claim 1, characterized by the fact that it comprises a plurality of said filters (2, 8) connected in series with each other, wherein:
said input ends (6) of the first of said coils (2) and said output ends (7) of the last of said coils (2) are directly connectable to said power line and to said power unit, respectively;
said output ends (7) of each said coil (2), except for the last one, are directly connected to said input ends (6) of each said next coil (2) to define, between two of said next filters (2, 8), four intermediate connections which are parallel to each other.

7) Circuit (1) according to claim 6, characterized by the fact that it comprises three of said filters (2, 8) connected in series.
